(19) United States
(12) Patent Application Publication
(10) Pub. No.: US 2017/0228356 A1
(43) Pub. Date: Aug. 10, 2017

(54) System Generator Module for Electronic Document and Electronic File

(71) Applicant: Kim Seng KEE, Kuala Lumpur (MY)

(72) Inventors: Kim Seng Kee, Kuala Lumpur (MY); Keong Hway Chhua, Kuala Lumpur (MY); Theng Soo Tan, Kuala Lumpur (MY); Kian Kok Cheung, Kuala Lumpur (MY)

(21) Appl. No.: 15/518,742

(22) PCT Filed: Oct. 13, 2015
(86) PCT No.: PCT/MY2015/050127

§ 371 Date: Apr. 12, 2017

(30) Foreign Application Priority Data
Oct. 13, 2014 (MY) PI2014703017

(51) Int. Cl. G06F 17/24; G06Q 10/10; G06F 21/62; G06Q 10/06; G06F 12/08; G06F 17/30

(52) U.S. Cl. CPC G06F 17/243; G06F 12/08; G06F 17/30557; G06F 17/246; G06F 21/6218; G06F 17/30011; G06Q 10/06311; G06Q 10/10

(57) ABSTRACT

A system to emulate manual filing system by storing and processing document that operates on Relational Database Management System (RDBMS), comprising; a Electronic Document (eDoc) (11) having at least one Electronic Document Identifier (eDoc-Identifier), Section, Rowtype and Column; a Electronic Form (eForm) Generator Module to create at least one Electronic Form (eForm) having a Predefined Program based on a Electronic Dictionary (eDict) data; a Flow Diagram having pre-compiled task program set by at least one user; a Electronic Business Processing Module (eBPM) Generator to generate at least one task program based on the Flow Diagram to be stored into the Electronic Document (eDoc) (11); a Mapping

Generator Module to generate data mapping program based on a graphical information; a Transaction Processing Module to store the generated Mapping Program; a System Generator Module to generate process control and business rules into pre-compiled program using Electronic Business Processing Module (eBPM); a Program Module having at least one Electronic Form (eForm) to capture data entry based on set of instructions and data fields that pre-defined in at least one Electronic Dictionary (eDict); a Virtual Memory for storing the Electronic Document (eDoc) (11); and a Web-Read Module (4) for retrieving the Electronic Document (eDoc) (11) from the Virtual Memory based on at least one identifier of Electronic Document (eDoc) (11).

### FIELD OF INVENTION

The proposed invention relates to a system and method to emulate manual filing system by storing and processing document that operates on Relational Database Management System (RDBMS).

### BACKGROUND ART

An age of integration—in which data, images, audio and video are used together, often in the same document or process—has generated a real need for an efficient, seamless and intuitive means of storing and retrieving all this digital information. This usually means having to manage complex relationships between stored entities. Traditional methods involve breaking up and placing parts of the data into various tables so that a relational database management system (RDBMS) can handle them: this highly complex task involves designing and managing relationships between data items stored in the various tables.

Software development for enterprise is complex and time consuming as it may require hundreds of man years. The main contributor to complexity is the tens of thousands of tables necessary in an enterprise system. The design of the database together with the primary and foreign keys complicates SDLC. Also tables require extra programs to link and split documents.

The legacy system that uses RDBMS as its database cannot store documents and folios, the documents and folios must be split into tables with different primary keys and foreign keys to be able to store onto RDBMS. The thousands of table designs must include all input tables, intermediate tables and output tables is a very complicated undertaking.

The thousands of tables complicate systems development life cycle (SDLC) & complicates data managements. Therefore, to provide a one view of customer folio, general ledger folio, stock folio, etc. is a difficult effort as the data must be transformed between each process (web, transmission, storage, processing (batch, on-line, BPM), data-warehousing, data-mining, output.

In Legacy system, it is difficult to integrate data & system because it is usually developed by different group as Legacy systems involve thousands of tables. The Documents, Flows, Business Rules & Codes are often lost in the process, therefore difficult for business personnel to talk to the computer people.

Because of the complexity, software changes are slow, complex & expensive, the dateline are difficult to meet. What is really needed is an efficient system which stores structured, semi-structured and unstructured data (and the schema which describes the data), and manages the relationships between data items.

Therefore an invention is proposed a system to emulate manual filing system by storing and processing electronic document that operates on Relational Database Management System (RDBMS).

### SUMMARY OF INVENTION

The present invention provides a system to emulate manual filing system by storing and processing document that operates on Relational Database Management System (RDBMS), comprising; a Electronic Document (eDoc) (11) having at least one Electronic Document Identifier (eDoc-Identifier), Section, Rowtype and Column; a Electronic Form (eForm) Generator Module to create at least one Electronic Form (eForm) having a Predefined Program based on a Electronic Dictionary (eDict) data; a Flow Diagram having pre-compiled task program set by at least one user; a Electronic Business Processing Module (eBPM) Generator to generate at least one task program based on the Flow Diagram to be stored into the Electronic Document (eDoc) (11); a Mapping Generator Module to generate data mapping program based on a graphical information; a Transaction Processing Module to store the generated Mapping Program; a System Generator Module to generate process control and business rules into pre-compiled program using Electronic Business Processing Module (eBPM); a Virtual Memory for storing the Electronic Document (eDoc) (11); and a Web-Read Module (4) for retrieving the Electronic Document (eDoc) (11) from the Virtual Memory based on at least one identifier of Electronic Document (eDoc) (11).

Preferably, the Web-Read Module (4) for retrieving the Electronic Document (eDoc) (11), further comprising; a Paging Module (7) having the Electronic Document (eDoc) (11) append into at least one Electronic File (eFile) in the RDBMS according to a predefined Page limit; a Index Module (8) having at least one Index for the Electronic File (eFile) based-on document identifier, date, end sequence number, document status, document offset and document length; and a Read Module (9) to obtain the Index and at least one Data Relative Page of the Electronic File (eFile) from the Index Module (8) based on the identifier, in which the Electronic Document (eDoc) (11) retrieved from the Paging Module (7) based on the retrieved Index and Data Relative Page to be stored in the Virtual Memory and update the Index Module (8).

Preferably, the identifier of Electronic Document (eDoc) (11) comprising the Electronic Document Identifier (eDoc-Identifier), Section, Rowtype and Column.

Preferably, the identifier of Electronic Document (eDoc) (11) comprising document identifier, date, end sequence number, document status, document offset and document length.

A further aspect of present invention provides a system to emulate manual filing system by storing and processing document that operates on Relational Database Management System (RDBMS), further comprising; a Enquiry Module for retrieving a pluralities of Electronic Document (eDoc) (11) information based on at least one Information for the Electronic Document Identifier (eDoc-Identifier), Section, Rowtype and Column of Electronic Document (eDoc) (11), in which the retrieved Electronic Document (eDoc) (11) information having at least one file history display into at least one list form.

Preferably, the list form having at least one predefined information for each document.

Preferably, the Enquiry Module, further comprising a Editing Module to load the retrieved Electronic Document (eDoc) (11) for updating the retrieved Electronic Document (eDoc) (11) and store at least one Updated Data to the Virtual Memory.

Preferably, the Enquiry Module, further comprising a Viewing Module to load the retrieved Electronic Document (eDoc) (11) for viewing the retrieved Electronic Document (eDoc) (11).

Preferably, the Enquiry Module further includes a Searching Module, wherein the Searching Module retrieves the Electronic Document (eDoc) (11) using the Web-Read Module (4) based-on at least one Index, in which the index is retrieved from the identifier of Electronic Document (eDoc) (11) comprising document identifier, date, end sequence number, document status, document offset and document length.

Preferably, the Web-Read Module (4) further includes a Uploading Module to upload the Electronic Document (eDoc) (11) based the identifier of Electronic Document (eDoc) (11), in which the Uploading Module establish connection to at least one server having RDBMS and update the RDBMS with the uploaded Electronic Document (eDoc) (11).

Another aspect of present invention provides a method to emulate manual filing system by storing and processing document that operates on Relational Database Management System (RDBMS), comprising steps of; obtaining a login authentication based on at least one user input; validating the login authentication of the user with at least one login details in a database; retrieving at least one user security matrix information of the valid user stored in the database; and displaying a menu having at least one list of predefined program stored in the database based on the user security matrix information.

Preferably, the displaying at least one selection menu stored in the database based on the user's security matrix information, further comprising steps of; loading at least one Electronic Business Processing Module (eBPM) Generator having a predefined program, if the user selected from the displayed menu; loading at least one Electronic Form (eForm) Generator Module having a predefined program, if the user selected from the displayed menu; and logging out and update the logout request time to the database, if the user selected from the displayed menu.

Preferably, the Loading at least one Electronic Business Processing Module (eBPM) Generator having a predefined program, further comprising steps of; displaying a menu having at least one list of predefined program stored in the Electronic Business Processing Module (eBPM) Generator; creating at least one workflow program, if the user selected from the displayed menu; saving the workflow program, if the user selected from the displayed menu; loading at least one predefined workflow program, if user selected from the displayed menu; and exiting the predefined program of Electronic Business Processing Module (eBPM) Generator, if the user selected from displayed menu.

A further aspect of present invention provides a method to creating at least one workflow program, further comprising steps of; displaying a menu having Start Component, End Component, Condition Component, Flow Component and Save Component stored in the database; generating a Start Component for workflow program based the user input, if the user selected from the displayed menu; generating a End Component for workflow program based the user input, if the user selected from the displayed menu; generating at least one Condition Component for workflow program based the user input, if the user selected from the displayed menu; generating at least one Flow Component for workflow program based the user input, if the user selected from the displayed menu; and saving the generated components for workflow program, if the user selected from the displayed menu.

A further aspect of present invention provides a method to saving the workflow program, further comprising steps of; extracting flow information from the workflow diagram; generating a graphical information from the flow information; storing the graphical information by using the Transaction Processing Module; generating a predefined program for at least one task of graphical information; integrating a mapping information for the task of graphical information using the Transaction Processing Module; and storing the mapped task using the Transaction Processing Module.

A further aspect of present invention provides a method to loading at least one predefined workflow program, further comprising steps of; displaying a menu having Design Program, Metering Program and View Program stored in the workflow program; authorizing the user to edit at least one predefined task properties stored in the workflow program, if the user selected the Design Program from displayed menu; verifying operational workflow for the predefined task using a Retrieval Module, if the user selected the Metering Program from displayed menu; and displaying all of the predefined task, if the user selected the View Program from displayed menu.

A further aspect of present invention provides a method to integrating a mapping information for the task of graphical information using the Transaction Processing Module, further comprising steps of; receiving the mapping instruction from a Mapping Program; extracting a mapping instruction contains mapping level, Source and Destination Row Identifier; interpreting the mapping instruction if the mapping is at Row or Column level of mapping level; validating if the mapping is at Row level; retrieving a Source and Destination Row eDicts using Read Module (9), if there is mapping at Row level; identifying a matching Source and Destination Column Name between the retrieved Source and Destination Row eDicts; verifying, if Source and Destination Column Name are matched; adding the matching Source and Destination Column pair into a temporally list, if Source and Destination Column Name are matched; validating if there are more column to match; validating if the mapping is at Column level; retrieving the Source and Destination Row eDicts using Read Module (9), if the mapping is at Column level; translating the Column Name into actual index based on the Row eDict retrieved; generating the Mapping Program using the identified Source and Destination index; generating at least one Condition and Computation based on mapping instruction received; and storing the generated Mapping Program to the database using Transaction Processing Module.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF PREFERRED EMBODIMENT

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

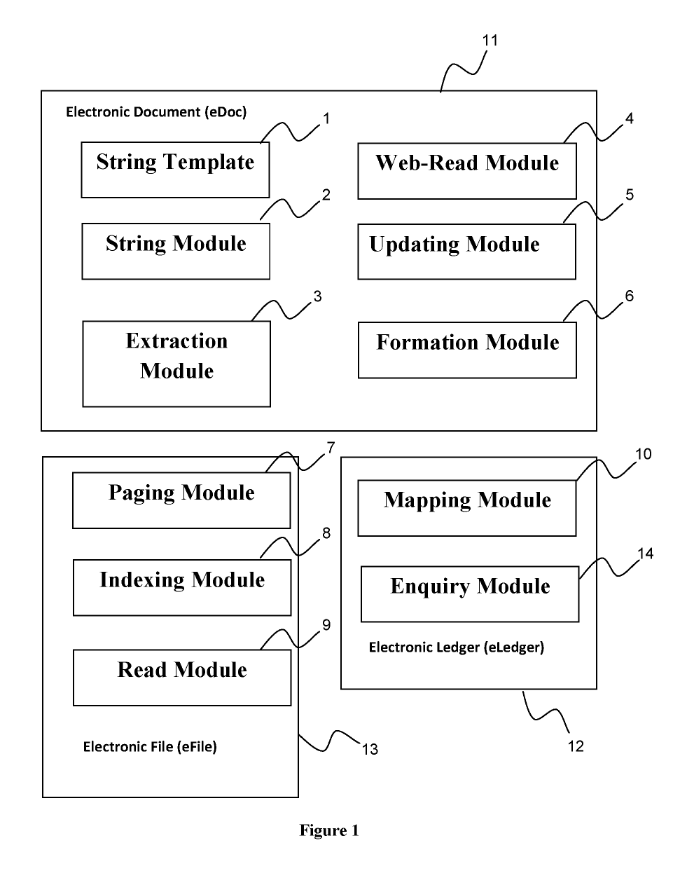

FIG. 1 illustrates overall architecture of the Electronic Document (eDoc) and Electronic File (eFile).

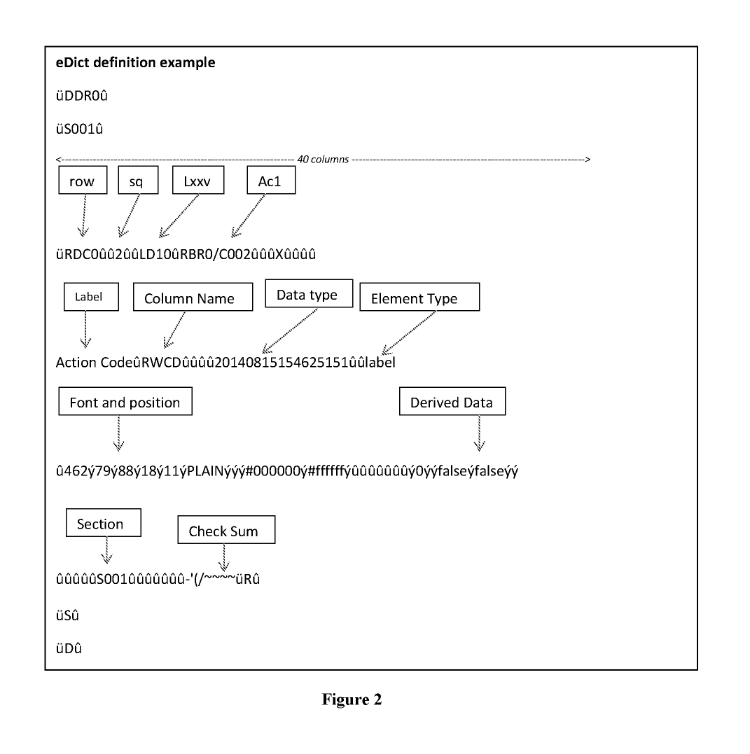

FIG. 2 illustrates an example of Electronic Dictionary (eDict) or metadata is used to describe the attribute/behavior in a string.

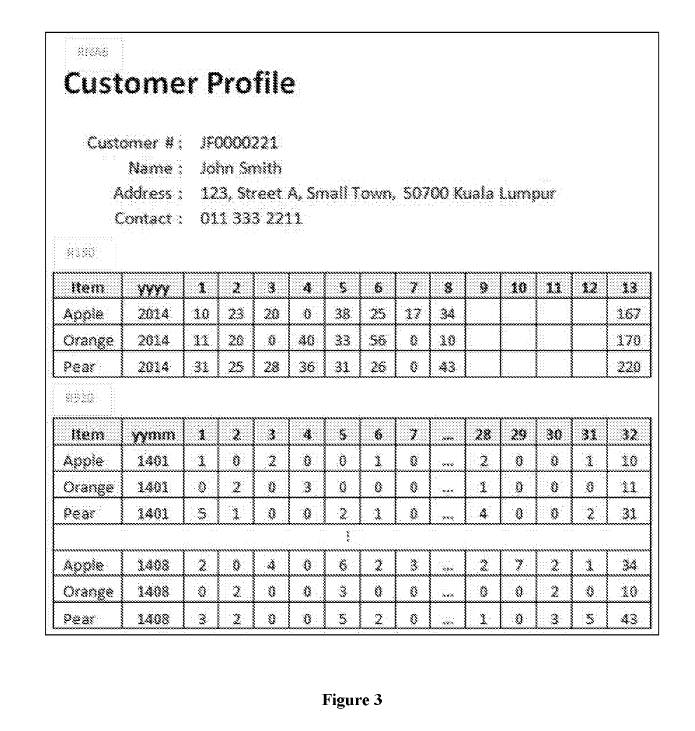

FIG. 3 illustrates an example eLedger containing details of a customer profile and item details.

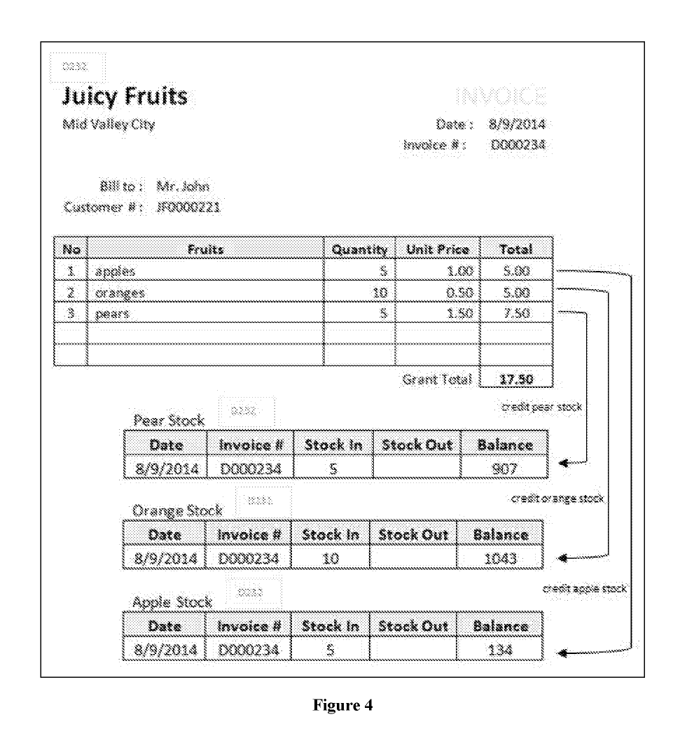

FIG. 4 illustrates an example creation of subDoc based on the example as in FIG. 3.

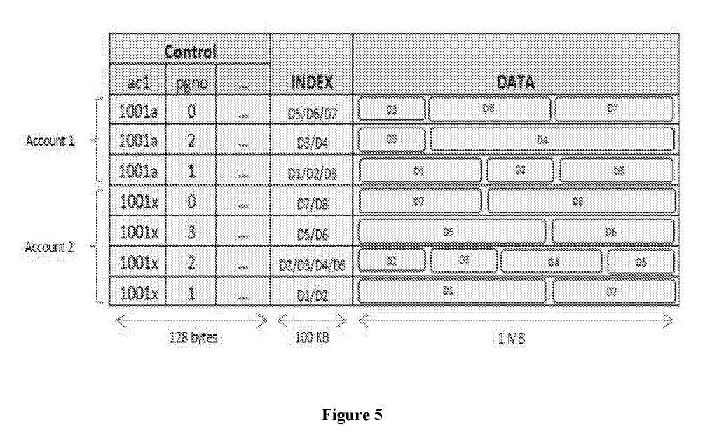

FIG. 5 illustrates an example of how eFiles store in a RDBMS Table.

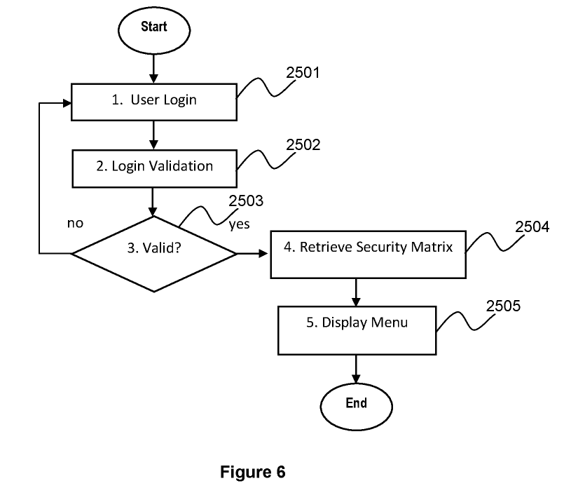

FIG. 6 illustrates flow chart of System Generator Module for login authentication process and menu display.

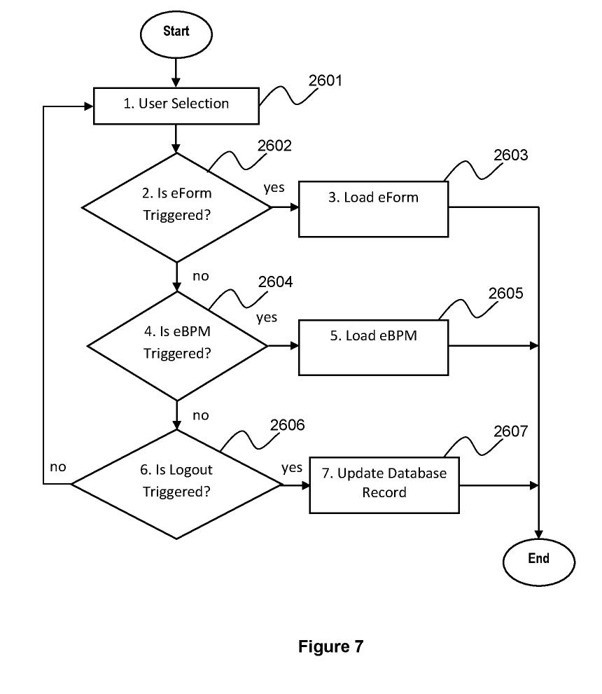

FIG. 7 illustrates flow chart of System Generator Module for user selection process from menu.

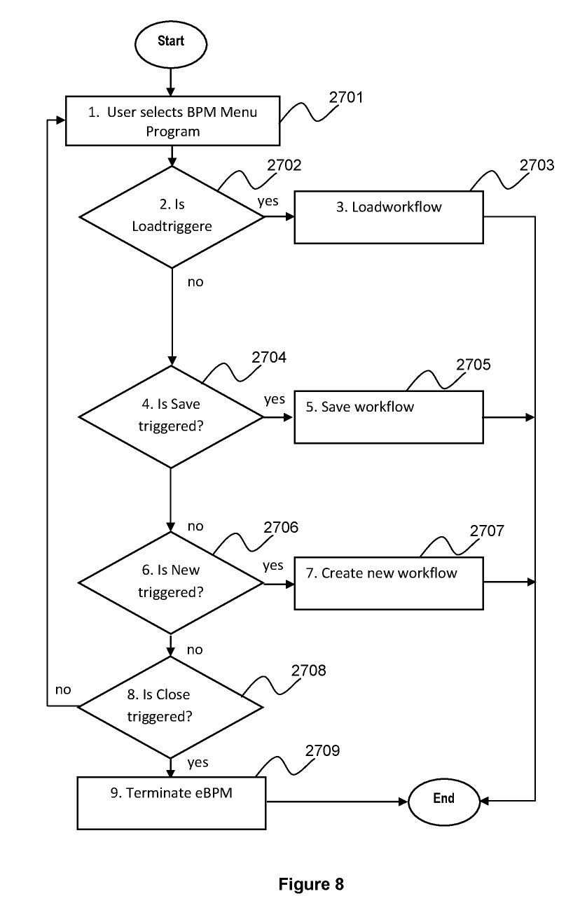

FIG. 8 illustrates flow chart of Electronic Business Processing Module (eBPM) Generator for user selection process from menu.

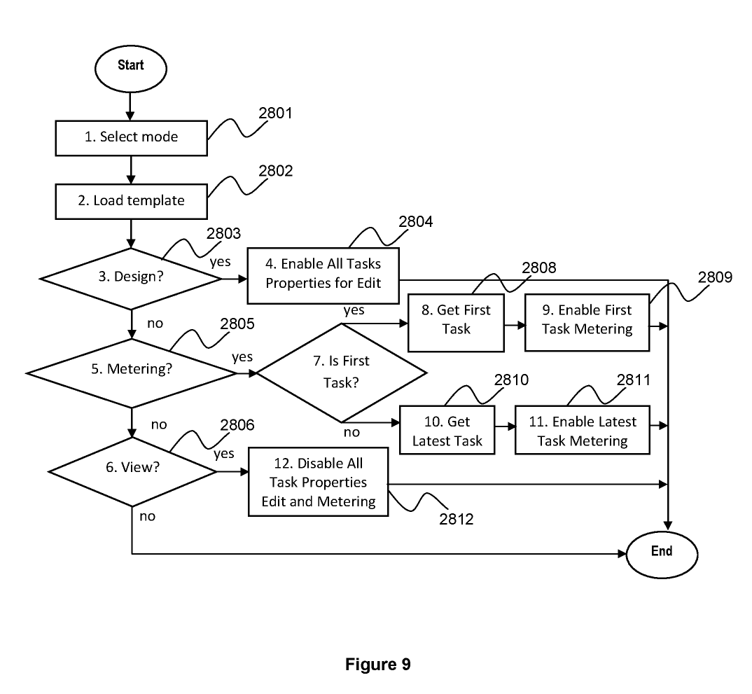

FIG. 9 illustrates flow chart of Electronic Business Processing Module (eBPM) Generator for Design, Metering and View operation modes.

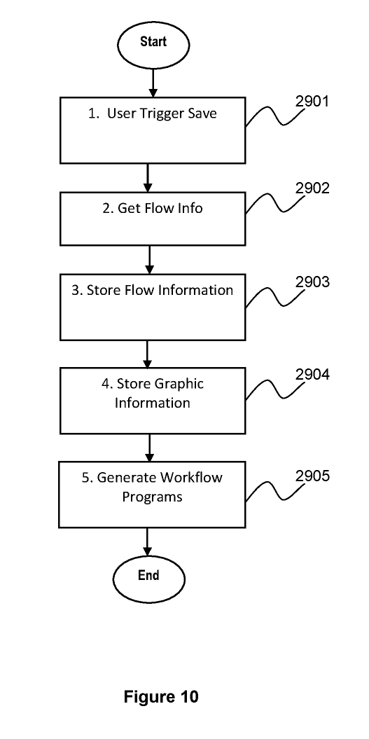

FIG. 10 illustrates flow chart of Electronic Business Processing Module (eBPM) Generator for saving a workflow of Design, Metering and View operation modes.

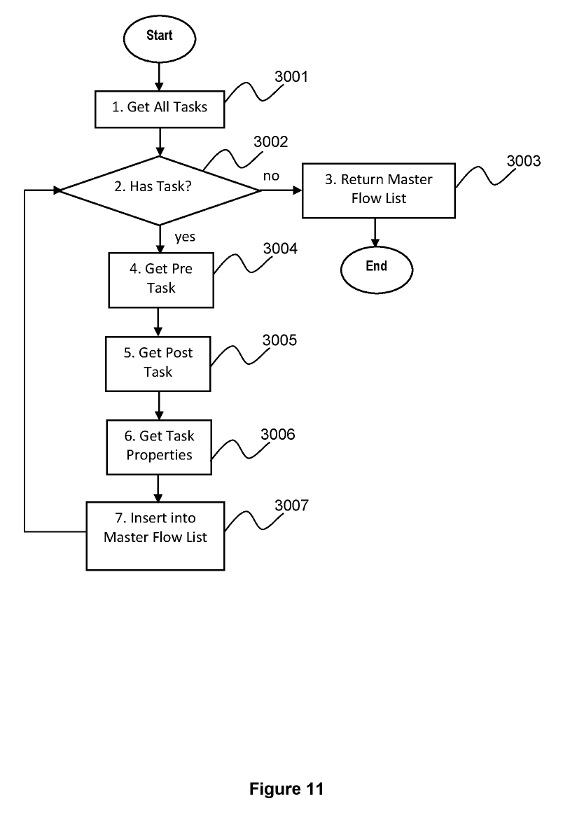

FIG. 11 illustrates flow chart of Electronic Business Processing Module (eBPM) Generator for extracting a workflow of Design, Metering and View operation modes.

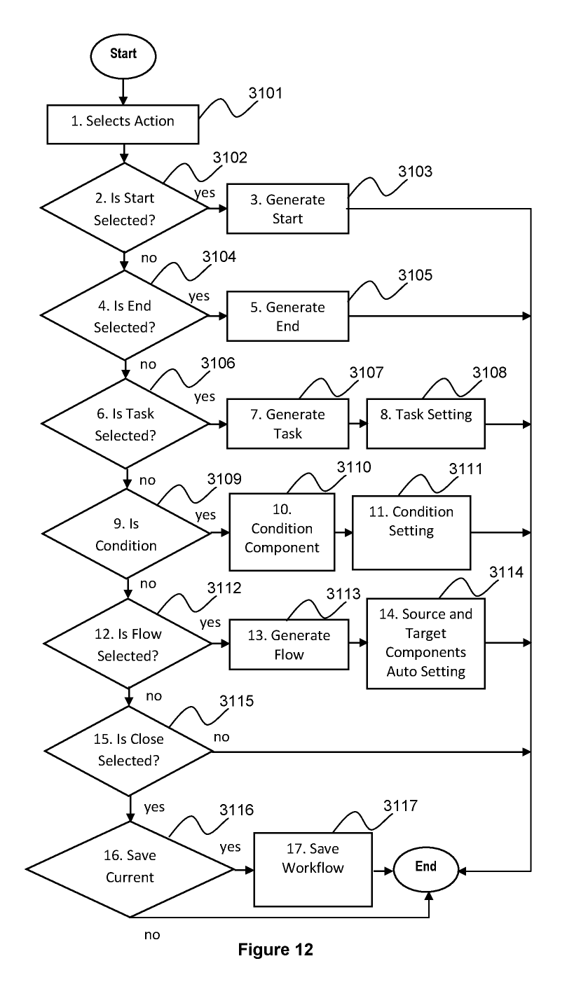

FIG. 12 illustrates flow chart of Electronic Business Processing Module (eBPM) Generator for forming a workflow of Design, Metering and View operation modes.

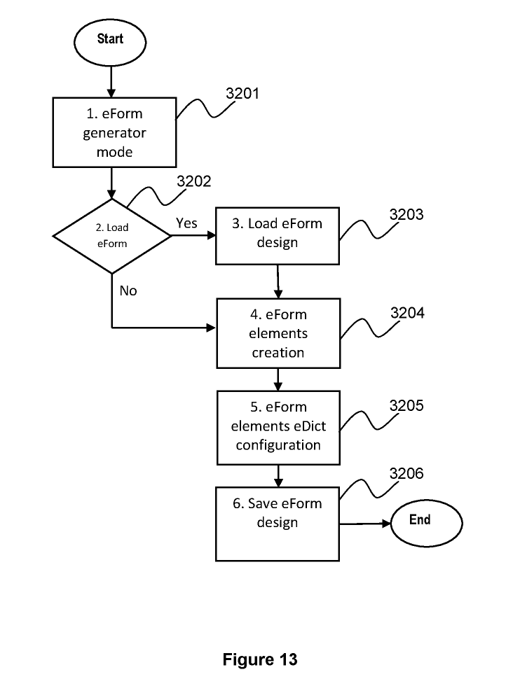

FIG. 13 illustrates flow chart of Electronic Form (eForm) Generator for adding elements based on Electronic Dictionary (eDict) into Electronic Form (eForm).

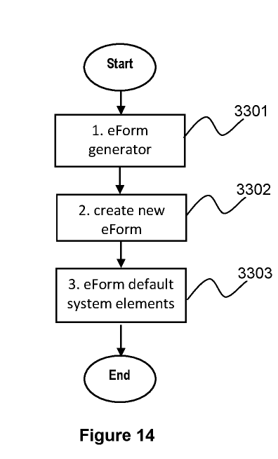

FIG. 14 illustrates flow chart of Electronic Form (eForm) Generator for generating a new Electronic Form (eForm).

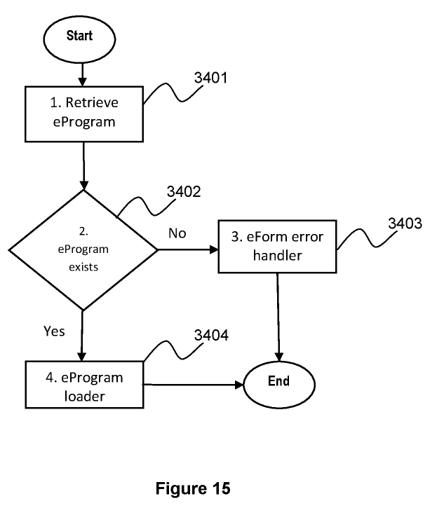

FIG. 15 illustrates flow chart of Electronic Form (eForm) Generator for generating a Electronic Form (eForm) based on predefined program.

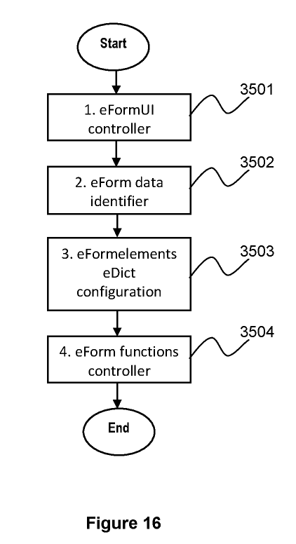

FIG. 16 illustrates flow chart of Electronic Form (eForm) Generator for forming a elements to be added based on Electronic Dictionary (eDict) into Electronic Form (eForm).

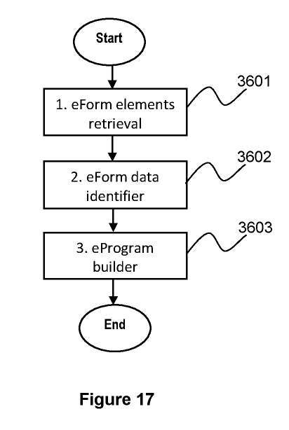

FIG. 17 illustrates flow chart of Electronic Form (eForm) Generator for forming a Electronic Form (eForm).

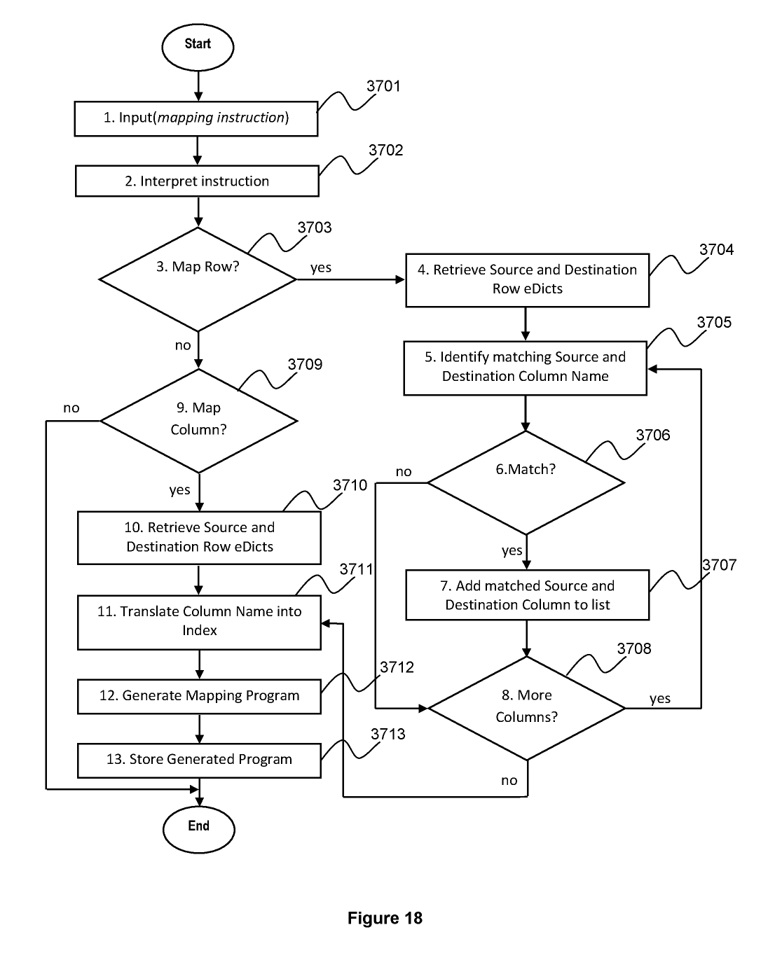

FIG. 18 illustrates flow chart of Mapping Generator for forming a Mapping Program based predefined mapping instructions.

### DETAILED DESCRIPTION OF THE PREFERRED EMBODIMENTS

The proposed invention relates to a system and method to emulate manual filing system by storing and processing document that operates on Relational Database Management System (RDBMS).

Data is stored in a format called Electronic Document (eDoc), which serves as the display, storage, processing, and transmission format throughout the systems development life cycle, without transformation at any stage. Data can be imported from or exported to any format including PDF, XML, XLS and CSV.

An Electronic File (eFile) stores eDocs (with all data file types) on a database (RDBMS). Filing System predominantly utilizes the database read, write and index functions only. Therefore it can utilise almost all popular RDBMS, and if necessary can handle any customised, in-house database systems.

As illustrated in FIG. 1, the system to emulate manual filing system for storing and processing document that operates on Relational Database Management System (RDBMS), comprising; a String Template (1) having at least one details of document number, number of sections and number of rows defined based on at least one Input; a String Module (2) for generate a Electronic Document (eDoc) (11) having at least one Electronic Document Identifier (eDoc-Identifier), Section, Rowtype and Column by validating the document number, number of sections and number of rows based on the String Template (1); and a Extraction Module (3) for extracting the Electronic Document Identifier (eDoc-Identifier), Section, Rowtype and Column of Electronic Document (eDoc) (11) generated by the String Module (2) for retrieval process. The system also includes a Retrieval Module (4) for retrieving at least one Retrieved Data from the data of Electronic Document (eDoc) (11) stored in the database based on at least one Input of the Section, Rowtype and Column; a Updating Module (5) for updating the Retrieved Data of Electronic Document (eDoc) (11) and store at least one Updated Data to the database based on the Input of Section, Rowtype and Column defined; and a Formation Module (6) for forming the updated Electronic Document (eDoc) (11) by retrieving the Updated Data based on the Input of Section, Rowtype and Column. Further, the system has a Paging Module (7) for append Electronic Document (eDoc) (11) in the database into at least one Electronic File (eFile) (13) according to a predefined Page limit; a Indexing Module (8) for forming at least one Index to the Electronic File (eFile) (13) based-on document identifier, date, end sequence number, document status, document offset and document length; and a Read Module (9) for retrieving the Index and at least one Data Relative Page (Page 0) of the Electronic File (eFile) (13) based on at least one Read Input to at least one Output. In addition the system further includes a Mapping Module (10) for updating at least one Retrieved Data based on at least one Mapping Input by determining the Electronic File (eFile) (13) using the Read Module (9) to retrieve the Retrieved Data of Electronic Document (eDoc) (11) using the Retrieval Module (4), in which the Updating Module (5) update the Retrieved Data to the database and forming the Retrieved Data into the Electronic Document (eDoc) (11) using the Formation Module (6) for updating into at least one Electronic File (eFile) (13) using Paging Module (7) and forming at least one Index using the Indexing Module (8); and a Enquiry Module (14) for retrieving a pluralities of Electronic Document (eDoc) (11) information using a Mapping Module (10) based on at least one Information for the Electronic Document Identifier (eDoc-Identifier), Section, Rowtype and Column of Electronic Document (eDoc) (11), in which the retrieved Electronic Document (eDoc) (11) information having at least one file history display into at least one list form.

eDoc Filing System account-centric system that acts as a display, transmission, storage and processing medium from end to end without requiring any other transformation or normalization.

Electronic File (eFile) is an electronic folio (similar to a file in conventional manual filing systems) where all types of documents with different data types can be stored together in an account-centric manner.

The Filing system logically stores all data and information that relate to a single account in an Electronic File (eFile), in chronological order. The Electronic Document (eDoc) are stored as sequential strings of data mapped to a data dictionary, and may include multiple data types in each string (e.g. image files, binary files, comma separated format, XML or any of the nearly 500 data formats in existence today). This allows the storage of any type of data within one record. The way eDoc stores its data provides near real-time data mining without the need for data modeling.

eDoc is a data storage format comprising strings containing multiple rows each preceded by a unique row code: RxxV-Rxx being the row# and V the version#. Multiple rows of data of various rows make an eDoc. All data is stored in variable length or fixed length columns. Each row contains multiple columns separated by terminators. There are special terminators for start and end of DxxV (documents), RxxV (rows), etc. eDoc is designed for change. Various versions of RxxV and DxxV can exist concurrently. eDoc can be converted to XML and vice versa. eDoc is similar to XML as its data also has separators and identifiers and tags, but eDoc has additional system fields that provide new functionality. If required, XML is used as a universal transmission document and passed to other systems, where data can be normalized to tables. The table 1.0 and 2.0 further describes the terminators (separator) and identifiers and tags.

eDoc String

Example of eDoc String-Data Structure: (Store in LxxV)

```
üDxxVû
  üSxxVû
    üRID0ûûûûûûûûûûûûûûûûûûûûûûûüRû
    üRxxVûûû ... ûûûüRû
    ...
    üRxxVûûû ... ûûûüRû
  üSû
  ...
  üSxxVû
  ...
  üSû
üDû
```

Terminators (Separator) Coding Structure

TABLE 1.0
Basic Separator

| Code | Separator | Example |
|---|---|---|
| üDxxVû | Start Document | üDJS4û-start of Job sheet |
| üDû | End Document | üDû |
| üSxxVû | Start Section | üS001û-start of 1^{st} Section |
| üSû | End Section | üSû |
| üRxxVû | Start Row | üRNA1û-start of Name/Address Row v1 |
| üRû | End Row | üRû |
| û | Field Separator | ûfield-1û . . . ûfield-n |
| ý | SubField | ý sub field-1 ý . . . ý subfield-n |
| | Separator | |
| ü[ | Open Packet | ü[üDJS1 . . . open packet for subDoc of |
| | | DJS1 |
| ü] | Close Packet | . . . üSûüDûü]close packet for the |
| | | subDoc |

LDSRC Coding Structure

TABLE 2.0

| Code | Description | Example |
|---|---|---|
| LxxV | Ledger Code | LJS4: Jobsheet Ledger version 4 |
| DxxV | Document Code | DJS4: Jobsheet Document version 4 |
| SxxV | Section Code | S001: Section 1 |
| RxxV | Row Code | RNA5: Name Address Rowtype version 5 |
| CxxV | Column Code | C005: Column 5 |
| VxxV | SubColumn Code | |

The Document Identifier (such as RID0) will only contain one or the whole Document, in which the Document Identifier is stored in the first Section. The Document Identifier contains details such as creator details, document details, update history, attributes and etc. Furthermore, the eDoc String data structure is also an Nth-dimension data structure where another eDoc String can be encapsulated within the ü[ . . . ü] and stored in a Column. The LDSRC Codes is also representing the GIS of an eDoc String stored. To retrieve the eDoc String, the LDSRC Codes are used to locate them.

Example of eDoc String: (Store in LHRO)

```
üDHR1û
  üS001û
    üRID0ûdxxvû1ûUûLHR0ûLD08003ûûûDHR1ûCûûûûûûûId1302
    EûLeave Applicationû12/12/2013ûûûû,&-.~~~~ûüRû
    üRNA5ûû1ûUûûûûûûûûûûûUploadûûûûûûNurul
    AfizabintilbrahimûLot No. 4 LrgKingland 1, TmnKingland Phase
    2, 88100 Petagas, KKûMalaysiaûNurulAfizabintilbrahimûDato
    Sri MikeûSisterû016-8451196ûûIT
    SUPPORTûFizaûûûûûûûûûû8ûSUPPORTûûûûûûûûûû1430996
    7û830430-12-5720ûûû454 101 9729û61692683û830430-12-
    5720û2000û2500û500ûûûûûûcobraangels@gmail.comûûûûûûû
    ûûûûûûûû20Oct08û20Jan09û29/11/2013û28/11/2013ûûûûûûûûû
    ûûûûûûûûûûûûûûûûûûûûûûûPETALING JAYûûûûûûû014
    3757463ûûûûûûûûûûûJunior Server
    AdministratorûûûûûûûFemaleûûokûokûokûRecommendedûûûû
    OTHERSû4.0û12ûûûû11.0û09/12/2013û1ûUûCREATIVEûûûû0
    0000036ûProject Loanûûûûû(,′,)~~~ûüRû
    üR133ûû1ûûûûûûûûûûûûûûûûû2û2û2013ûûûD318ûALûûûûûûû′
    ′,(~~~~ûüRû
    üRRpD1ûû1ûûûûûûûûûûûûûûûûûûûûûûûûûûtesting approve
    10.40ûûûûûûûûûûûûûûûûûûûûûûûûûûûûûûûûûûûûûûûûûûûûûû
    ûûûûûûûû04/12/2013ûûûûûûûûûûûûûûûûûûûûûûûûûûûûûûûûûa
    aaaaaaaûûûûûûûûûûûûûûûûûûûûûûûûûûû111ûûûûûûûûûûûûûû
    ûûûûûûûûûûûûûûûûûûûûûû*&&-~~~~ûüRû
    üR134ûD313û1ûûûûûû1640ûûûûûûûûûûûû1640û2014ûûûûPER
    SONALLOANûû
      ü[
        üDHR1ûüS001ûüRID0ûdxxvû1ûUûLHR0ûLD0800
        3ûûûDHR1ûCûûûûûûûId1302EûLeave
        Applicationû12/12/2013ûûûû,&-.~~~~ûüRû
        üRR134ûD313û1ûûûûûû1640ûûûûûûûûûûûû1640
        û2014ûûûûPERSONALLOANûûûûûûû(′-
        +~~~~ûüRûüSûüDû
      ü]
    ûûûûû(′-+~~~~ûüRû
  üSû
üDû
```

eDict

As illustrated in FIG. 2, the Electronic Dictionary (eDict) or metadata is used to describe the attribute/behavior of each ledger (LxxV), document (DxxV) and Rowtype (RxxV). For LxxV level, the ledger identifier, eDoc updating methods (FIFO, LIFO, Update or Overwrite) and number of eDoc to be kept in eLedger is predefined in Ledger type eDict. For DxxV level, the document type to be or can be stored is predefined in the Document type eDict. For RxxV level, the Rowtype type eDict is categorized into 3 parts; first, general attributes such as name, data type, data length and so forth; second, display attributes such as font type, size, color and so forth; third, computation attributes like data validation and computation. The table 3.0, 4.0 and 5.0 shows an example of metadata or library predefined for Ledger, Document and Rowtype.

Ledger eDict—Definition

TABLE 3.0
Dictionary

| # | Name | Function | Length | Description |
|---|---|---|---|---|
| 1 | row | data | 4 | RDL0 |
| 2 | doc | data | 4 | Document (DxxV) |
| 3 | sq | data | 4 | Sequence# |
| 4 | st | data | 2 | Status |
| 5 | lg | data | 4 | LD10 |
| 6 | ac1 | data | 16 | Ledger (LXXV) |
| 7 | ac2 | data | 16 | |
| 8 | proj | data | 4 | Project |
| 9 | datatyp | data | 1 | |
| 10 | usg | data | 1 | |
| 11 | opt | data | 1 | |
| 12 | subfield | data | 4 | |
| 13 | nm1 | data | 32 | Ledger name |
| 14 | nm2 | data | 32 | Update method (FIFO/LIFO/U/O) |
| 15 | le | data | 2 | Max document |
| 16 | de | data | 1 | |
| 17 | def | data | 16 | |
| 18 | hid | data | 10 | |
| 19 | htag | data | 4 | |
| 20 | htype | display | 4 | |
| 21 | hstyle | display | 255 | |
| 22 | lig | data | 255 | |
| 23 | dup | entry | 1 | |
| 24 | msk | display | 200 | |
| 25 | cond | compute | 255 | |
| 26 | comp | compute | 255 | |
| 27 | next | compute | 4 | |
| 28 | der | data | | |
| 29 | mnle | validate | 2 | |
| 30 | mxv | validate | 14 | |
| 31 | mnv | validate | | |
| 32 | res1 | reserved | | |
| 33 | res2 | data | 4 | |
| 34 | res3 | reserved | | |
| 35 | res4 | reserved | | |
| 36 | res5 | reserved | | |
| 37 | bal | data | | balance |
| 38 | size | data | | Size of this row |
| 39 | secu | data | 8 | Security |
| 40 | cksum | data | 8 | Checksum |

Document eDict—Definition

TABLE 4.0
Dictionary

| # | Name | Function | Length | Description |
|---|---|---|---|---|
| 1 | row | data | 4 | RDD0 |
| 2 | doc | data | 4 | Document (DxxV) |
| 3 | sq | data | 4 | Sequence# |
| 4 | st | data | 2 | Status |
| 5 | lg | data | 4 | LD10 |
| 6 | ac1 | data | 16 | Doc (DXXV) |
| 7 | ac2 | data | 16 | |
| 8 | proj | data | 4 | Project |
| 9 | datatyp | data | 1 | File type (Excel/Email/bin/eDoc) |
| 10 | usg | data | 1 | |
| 11 | opt | data | 1 | |
| 12 | subfield | data | 4 | |
| 13 | nm1 | data | 32 | Document name |
| 14 | nm2 | data | 32 | |
| 15 | le | data | 2 | Size of Doc |
| 16 | de | data | 1 | Version |
| 17 | def | data | 16 | |
| 18 | hid | data | 10 | |
| 19 | htag | data | 4 | |
| 20 | htype | display | 4 | |
| 21 | hstyle | display | 255 | |
| 22 | lig | data | 255 | |
| 23 | dup | entry | 1 | |
| 24 | msk | display | 200 | |
| 25 | cond | compute | 255 | |
| 26 | comp | compute | 255 | |
| 27 | next | compute | 4 | |
| 28 | der | data | | |
| 29 | mnle | validate | 2 | |
| 30 | mxv | validate | 14 | |
| 31 | mnv | validate | | |
| 32 | res1 | reserved | | |
| 33 | res2 | data | 4 | |
| 34 | re53 | reserved | | |
| 35 | res4 | reserved | | |
| 36 | res5 | reserved | | |
| 37 | bal | data | | balance |
| 38 | size | data | | Size of this row |
| 39 | secu | data | 8 | Security |
| 40 | cksum | data | 8 | Checksum |

Rowtype eDict—Definition

TABLE 5.0
Dictionary

| # | Name | Function | Length | Description |
|---|---|---|---|---|
| 1 | row | data | 4 | RDC0 |
| 2 | doc | data | 4 | Document (DxxV) |
| 3 | sq | data | 4 | Sequence# |
| 4 | st | data | 2 | Status |
| 5 | lg | data | 4 | LD10 |
| 6 | ac1 | data | 16 | RowCol (RxCx) |
| 7 | ac2 | data | 16 | |
| 8 | proj | data | 4 | Project |
| 9 | datatyp | data | 1 | Data (9/A/X/B/D/T) |
| 10 | usg | data | 1 | Usage (C/Blank) |
| 11 | opt | data | 1 | Optional |
| 12 | subfield | data | 4 | Subfield |
| 13 | nm1 | data | 32 | Label |
| 14 | nm2 | data | 32 | Name of column |
| 15 | le | data | 2 | Max Length |
| 16 | de | data | 1 | Decimal (2 dec) |
| 17 | def | data | 16 | Default |
| 18 | hid | data | 10 | HTML ID |
| 19 | htag | data | 4 | HTML Type |
| 20 | htype | display | 4 | # of elements |
| 21 | hstyle | display | 255 | Font, x, y, etc |
| 22 | lig | data | 255 | URL |
| 23 | dup | entry | 1 | Duplicate |
| 24 | msk | display | 200 | Mask |
| 25 | cond | compute | 255 | Condition |
| 26 | comp | compute | 255 | Computation |
| 27 | next | compute | 4 | Tab index |
| 28 | der | data | — | Derived Data |
| 29 | mnle | validate | 2 | Minimum length |
| 30 | mxv | validate | 14 | Maximum value |
| 31 | mnv | validate | | Minimum value |
| 32 | res1 | reserved | | |
| 33 | res2 | data | 4 | Section |
| 34 | res3 | reserved | | |
| 35 | res4 | reserved | | |
| 36 | res5 | reserved | | |
| 37 | bal | data | — | |
| 38 | size | data | — | Size of this row |
| 39 | secu | data | 8 | Security |
| 40 | cksum | data | 8 | Checksum |

Example of eDict Structure

üDDR0û
üS001û
<--------------------- 40 columns in horizontal representation ------------------
----------->
üRDC0û doc û sq û st û lg û ac1 û ac2 û proj û datatyp û usg û opt û
subfield û nm1 û nm2 û le û de û def û hid û htag û htype û hstyle û
lig û dup û msk û cond û comp û next û der û mnle û mxv û mnv û
res1 û res2 û res3 û res4 û res5 û bal û size û secuû cksumüRû
üSû
üDû

eLedger

Electronic Ledger (eLedger) is where summaries or derivatives of eFile that is kept in variable length or fixed length format thus allowing for greater flexibility and fast retrieval. The Information in eLedger can be deleted and modified. Each eFile can have multiple eLedgers if required (for speedy reporting purposes). The update method of each eDoc to the eLedger is predefined in eLedger dictionary. The eLedger can contain n copies of eDoc that arrange in FIFO or LIFO manner; or new eDoc can override the exiting eDoc in the eLedger; or the update only manipulate data from certain column(s) in eDoc with the predefine column(s) in eLedger. The system may further include Zero Balancing function where every transaction can be traced and no information is ever deleted, which means everything will be balanced (always balance to last cent). All transactions have a copy in the Transaction Ledger, so changes to any account are immediately verifiable and problems isolated. The system also may make the system naturally SOX Compliant (Sarbanes—Oxley Act of 2002). The system may further include Reverse Processing where a new eLedger can be generated or regenerated from eFile based on new configuration or updated configuration.

As illustrated in FIG. 3, the eLedger contains example customer profile that includes customer details (RNA6—Name and Address Rowtype) and summary of total item such as apple, orange and pear bought daily (R320—32-day Rowtype) and monthly (R130—13-month Rowtype) for year 2014. The summary in the eLedger are populated from the daily transactions in eFile.

Rowtype Header & Footer

TABLE 6.0

| sq | name | description |
|---|---|---|
| 1 | RxxV | rowtype |
| 2 | RWCD | row code |
| 3 | RWSQ | sequence |
| 4 | RWST | status |
| 5 | RWLG | ledger |
| 6 | RWA1 | account 1 |
| 7 | RWA2 | account 2 |
| 8 | RWCO | company & department |
| . . . | . . . | |
| n + 1 | RWBA | balance |
| n + 2 | RWSZ | size |
| n + 3 | RWSE | security |
| n + 4 | RWCS | checksum |

All Rowtype contains a Header with 8 columns and a Footer with 4 columns as shown on the Table 6 above. The row code (RWCD) of the Rowtype Header indicates its uniqueness among other same Rowtypes that appear within a Section and ledger (RWLG), account 1 (RWA1), account 2 (RWA2) and company & department (RWCO) indicates the location of the Rowtype in the database. The security (RWSE) of the Rowtype Footer is used to ensure that the right user(s) can access this row and the checksum (RWCS) is to ensures the data within the row is not corrupted.

Subsequent Documents (SubDoc)

As illustrated in FIG. 4, the creation of Subsequent Documents (subDoc), where the system splits a Doc so that it can be debited/credited to relevant account, each subDoc is appended as a string one after another. The Main Doc and subDoc(s) will have the same document identifier. For example, an invoice with document identifier, D232 may have a subDoc to debit customer account and subDoc to credit Apple, Orange and Pear Stock. (Referring to the example in FIG. 2).

Reserve and Commit

It's a process where a set of predefined requirements have to be adhered before any updating can take place. For example in an invoice, the requirements will be the customer must have sufficient credit to be debited from the account and there must be sufficient stock to be stocked out before the process is committed.

Header+Index+Data

As illustrated in FIG. 5, the eFiles are stored in a RDBMS table, where the table comprises of Control, Index and Data. The Control section contains key and details about the Page. The Index is used to locate the location of each eDoc in a Page, where the Indexing are done in Horizontal manner to create sub-filing system within a filing system. The Data is where the eFile is stored.

Example of Index for Account 1, Relative Page is as below:

DHR0:20140828: 5: U: 0: 122/DHR0:20140828: 6: U: 122:
250/DHR0:20140828: 7: U: 250: 372/

Each account contains a eFile and the eFile contains number of eDocs. The eFile is chopped into Pages according to Page size before storing into RDBMS. The Page number begins from Relative Page and when a new Page is added, the Relative Page is advanced to Page 1 and the Page number of the newly added Page is 0 and so forth. Besides that, Relative Page is also a relative page to the system; the enquiry will always start from Relative Page.

The Control section may also include the following:
Ig—ledger identifier
ac1—account 2
Ipgn—last page no
ssq—start document sequence no
sin—start Page line no
esq—end document sequence no
eIn—end Page line no
date—last updated date
st—the status of the eFiie such as deleted
co—company and department
bal—balance of all eDocs

The System Generator Module is a IT system/software generator used for software generator. This is used by IT or non-IT professional to create a software or IT system. Applicator is named as user of the System Generator Module. Applicator transform the manual system to IT system through System Generator Module.

The Electronic Business Processing Module (eBPM) Generator is an intelligent graphical tools used by applicator to create a system flow diagram and system flow program. When applicator created and saved a system flow diagram, Electronic Business Processing Module (eBPM) Generator will generate task in system flow into program and store into Electronic Document (eDoc).

The Electronic Business Processing Module (eBPM) Generator also allows users to print, view, design and edit a system flow. The changes of IT system/software system flow can be done immediately through Electronic Business Processing Module (eBPM) Generator. Applicator only needs to edit the graphical system flow diagram to modify the system flow program. Electronic Business Processing Module (eBPM) Generator able to capture and update the changes to the system flow program automatically.

Electronic Form (eForm), one of the module in the System Generator Module, main objective is to generate electronic form to capture user inputs, and store into Electronic Filing System (eFiling) for further process.

It is very common for users to captures inputs online or offline with electronic form, but making Electronic Form (eForm) so unique and different are, not only Electronic Form (eForm) can generate electronic form, it also allow users to create a new Electronic Form (eForm) within one man day, even users with the least training and knowledge on System Generator Module.

Users can also include Electronic Form (eForm) functions for (LLG—a library of Electronic Form (eForm) pre-created program) some special actions, for example manipulating another element in Electronic Form (eForm), fetch data from Electronic Filing System (eFiling) etc. This allows Electronic Form (eForm) to also perform as system application with complicated actions. Within Electronic Form (eForm) design mode, users can also setup Electronic Dictionary (eDict) for each element, thus granting more control over Electronic Form (eForm), for example position of elements, or control for data validation, setting the default value etc.

To adapt the changing nature of modern business, Electronic Form (eForm) is designed that it can read and display even with different version of Electronic Form (eForm), as long as identifiers are correct, Electronic Form (eForm) allow users to apply minor modification with least training.

Electronic Form (eForm) can cope with Electronic Business Processing Module (eBPM) Generator, allow Electronic Business Processing Module (eBPM) Generator to call and display targeted Electronic Form (eForm) with Electronic Document (eDoc), and also granted the control over sections activities, and capture process time for further computations. And with the Mapping Generator Module, the Electronic Form (eForm) capture data and send to Mapping Generator Module to further process.

The Mapping Generator Module is used to generate and integrate business rules in eSG. Mapping Generator Module is created in fast way through User-Interface (UI). Mapping Generator Module also enable user to set conditions and computations to illustrates the business rule. The business rules are generated in a program and integrate with Electronic Business Processing Module (eBPM) Generator. In convention system, mapping is executed by every single value. In Mapping Generator Module, it can be executed by column (single value) and row based (multiple values).

System Generator Module

The System Generator Module generates forms/modules/components into pre-compiled programs without required extensive analysis works through Electronic Form (eForm). The System Generator Module generates system flow and performs system integration through Electronic Business Processing Module (eBPM). Further, it also generates business rules program through Mapping Module, which can support row and column based data mapping.

The System Generator Module able to generate process control and business rules into pre-compiled Program through Electronic Business Processing Module (eBPM). The System Generator Module enables real time system modification without source code modification. All the business rules, system flow and system validation changes can be done through Electronic Form (eForm) and Electronic Business Processing Module (eBPM).

The System Generator Module uses one standard data storage table design and uses one standard data file system design in all generated system by using a standard name coding structure for all system components.

All of the System Generator Module generated programs are named accordingly to ease for versioning and the generated programs able to support concurrent processing as the Coding structure enables generated system components semantically understandable and eliminates system conflicts.

Electronic Business Processing Module (eBPM) Generator

The Electronic Business Processing Module (eBPM) Generator generates system flow control automatically when user create/edit system flow diagram. The Electronic Business Processing Module (eBPM) Generator also generates every task in workflow to executable programs to reduce system compilation time, where the task is generated into program and store into Electronic Document (eDoc). Furthermore the Electronic Business Processing Module (eBPM) Generator edits, updates and saves any information in document format. This allows user to set the business rules without changing the source code. Business rules can be set or edit in the Electronic Business Processing Module (eBPM) Generator system flow diagram level.

The Electronic Business Processing Module (eBPM) Generator increases the speed of process by reuse the document in system flow. All data is stored in that particular document to be processed by next user. When next user executes the task in the same operational workflow, there is no further data processing to prepare the task. The Electronic Business Processing Module (eBPM) Generator enables user to execute task by loading pre-compiled task program.

Electronic Form (eForm) Generator Module

Electronic Form (eForm) Generator provides a variety of tools that assist user on create a new Electronic Form (eForm) or load and update existing Electronic Form (eForm), for example creation and insertion of elements into Electronic Form (eForm), retrieve existing Predefined Program, data identifier selection etc.

The Electronic Form (eForm) Generator can load Electronic Form (eForm), retrieve and display the design and save the final design as Predefined Program for Electronic Form (eForm). The Electronic Form (eForm) Generator includes controller that will oversee user design for Electronic Form (eForm), and will alert and guide user on creating a valid Electronic Form (eForm), for example duplication control, data identity, Electronic Dictionary (eDict) configuration, to ensure created Electronic Form (eForm) can process data which compatible to Electronic Document (eDoc)design.

The Electronic Form (eForm) Generator also allows user to assign the pre-programmed functions to Electronic Form (eForm) elements and the functions will be triggered according to users action.

The Electronic Form (eForm) Generator customize normal form elements, to be able to interact with Electronic Dictionary (eDict), each element have its own storage to store its own set of Electronic Dictionary (eDict) data.

Mapping Generator Module

The Mapping Generator Module allows user to generate data mapping program through User Interface (UI), without any source code development by user. The Mapping Generator Module also generates business/mapping rules into executable program, including computation and condition setting. The Mapping Generator Module able to support row based (multiple values) and column based (single value) data mapping.

As illustrated in FIG. 6, the System Generator Module initiates once the login authentication by User key in login detail, which are username and password (2501). Then, System will perform validation with the username and password (2502). Validate the login details (2503). Thereafter, retrieve user's security matrix information for further processing, If login detail is valid (2504). Then, System will display the System Generator menu based on user's role, department and security matrix access (2505).

As illustrated in FIG. 7, the User will trigger any menu item to execute particular program (2601). Verify, If eForm is triggered by user (2602). The, System will load eForm predefined program and ends, If eForm is triggered (2603). Thereafter, verify, If eBPM is triggered by user (2604). If eBPM is triggered, System will load eBPM predefined program (2605). Then, verify further If Logout is triggered (2606). The System will update the log out time before the program end, If Logout is triggered by user (2607).

As illustrated in FIG. 8, the Electronic Business Processing Module (eBPM) Generator initiates once the User to selects which program from BPM Menu (2701). Then Verify, If user selection is Loaded (2702). If user selection is Load, System will load the Workflow predefined program and ends (2703). However, If user selection is not Load, then further verify, If user selection is Save (2704). If user selection is Save, System will load Save Workflow program and ends (2705). However, If user selection is not Save, then further verify, If user selection is New (2706). If user selection is New, System will load New Workflow program and ends (2707). However, If user selection is not New, then further verify If user selection is Close (2708). If user selection is Close, System will terminate BPM program (2709).

As illustrated in FIG. 9, the Electronic Business Processing Module (eBPM) Generator initiates once the User selects operation mode and the workflow to be loaded by using Read Module (2801). There are total three operation modes, which are Design, Metering and View. Then, the System will load the selected workflow template based on user selection (2802). Verify, If user selected operation mode is Design (28031). If user selected operation mode is Design, System enable user to enable all tasks properties for edit and ends (2804). However, If user selected operation mode is not Design, the system further Verify, If user selected operation mode is Metering (2805). Then further verify, If user selected operation mode is View (2806). If user selected operation mode is Metering System will check the operational workflow task listing by using Retrieval Module. Then further verify, If user selected task is the first (2807). In Metering mode, System will retrieve first task of the workflow by using Retrieval Module (2808). Then, the workflow is stored in eDoc. Thereafter, the System enables first task to be executed and metering, then ends (2809). However, If user selected task is not the first task In Metering mode, System retrieves the latest task for that particular operational workflow by using Retrieval Module (2810). Then, the System enables latest task to be executed and metering, then ends (2811). On the other hand, If user selected operation mode is View, System will load and disable all tasks in that particular workflow and ends (2812).

As illustrated in FIG. 10, the Electronic Business Processing Module (eBPM) Generator initiates once the User triggers save program (2901). Then, the System will extract system flow information from the workflow diagram (2902). Further, the System will trigger Generate Flow program to perform the flow information extraction (2903). Thereafter, the System will store the extracted system flow information by using Transaction Processing Module (2903). Then, the System also will store the graphical information by using Transaction Processing Module (2904). Finally, the System will generate the program for every task in the workflow, integrate the Electronic Mapping programs and stored it by using Transaction Processing Module (2905).

As illustrated in FIG. 11, the Electronic Business Processing Module (eBPM) Generator initiates by extracting all task components from system flow diagram and store into task list (3001). Verify, If there is more tasks in the list (3002). If there is no more tasks in the list, then the System will compile all tasks and return the master flow list, then ends (3003). However, If there is more tasks in the list, then the System will extract pre task information, such as task type, document identifier and section (3004). Then, the system will extract post task information, such as task type, document identifier and section (3005). Thereafter, the system also extract task properties, such as task name, task description, auto task, pre task data, document identifier, section identifier, user account, role, department and email (3006). Finally, all the extracted information will be inserted into master flow list memory (3007), then verify further, If there is more tasks in the list (3002).

As illustrated in FIG. 12, the Electronic Business Processing Module (eBPM) Generator initiates once the User selects an action to perform (3101). Verify, If Start is selected by user (3102). If Start is selected by user, System generates Start component in Editor (3103). However, if Start is not selected by user, then further verify if End is selected by user (3104). If End is selected by user, System generates End component in Editor (3105). However, if End is not selected by user, then further verify If Task is selected by user (3106). If Task is selected by user, System generates Task component in Editor (3107). Then, user performs Task Setting, then end (3108). However, if Task is not selected by user, then further verify If Condition is selected by user (3109). If Condition is selected by user, System generates Condition component in Editor (3110). User performs Condition Setting, then end (3111). However, if Condition is not selected by user, then further verify If Flow is not selected by user (3112). If Flow is selected by user, System generates Flow component in Editor (3113). Then, User performs source and target components setting, then end (3114). However, if Flow is not selected by user, then further verify If Close is selected by user (3115). If user does not save current workflow, then end (3116). However, If user save current workflow, System perform Save Workflow program (3117).

As illustrated in FIG. 13, the Electronic Form (eForm) Generator initiated by eForm generator to create the interface with tools that assist user on developing eForm into Predefined Program (eProgram), and a blank new eForm with default system elements (3201). Then, the system Check if user wants to load an existing eForm to process (3202). If user wants to load an existing eForm to process, retrieve and load eForm from database through Read Module (3203). Thereafter, the User can create and insert new element into eForm by provided tools on interface of eForm generator (3204). These elements are customized to interact with eDict, so that every element can store a set of eDict that will represent the elements on eForm. Then, the User may configure eDict for elements on eForm by provided tools on interface of eForm generator (3205). Finally, Save eForm design into Predefined Program (eProgram) and store into database (3206).

As illustrated in FIG. 14, the Electronic Form (eForm) Generator initiated by the interface to design and process an eForm, this component create tools that can be use by user to create and insert elements into eForm, configure eDict of eForm elements, retrieve and load existing eForm design from database, etc (3301). Then, Creating a new empty eForm with system default background image (3302). Finally, Creating and insert eForm default system elements into new created eForm, these system elements is important to identify an eForm, to prevent any eForm miss out these elements (3303).

As illustrated in FIG. 15, the Electronic Form (eForm) Generator initiated by Retrieve Predefined Program (eProgram) from database by using read module (3401). Then verify, if loading Predefined Program (eProgram) exists in the database (3402). If loading predefined Program not exists in the database, alert user (3403). However, If loading Predefined Program (eProgram) exist in the database, retrieve and load predefined Program into eForm generator (3404).

As illustrated in FIG. 16, the Electronic Form (eForm) Generator initiated by eForm UI controller which will identify which type of elements user is creating, create elements and insert into eForm (3501). Then, Each created elements serve as a container to capture data with certain identifier that match to format of eDoc, for example data identity and duplication control (3502). Thereafter, the User then configure eDict for elements on eForm by provided tools on interface of eForm design, example of eDict: position of element, condition and computation, maximum and minimum length of characters, maximum and minimum value etc (3503). Finally, eForm functions controller grant control on eForm elements toexecute eForm functions on user action (3504).

As illustrated in FIG. 17, the Electronic Form (eForm) Generator initiated by Retrieve all elements from eForm to process (3601). Thereafter, Retrieve and identify data from retrieved eForm elements (3602). Finally, all the retrieved elements and data, the system will build an Predefined Program (eProgram) for future use (3603).

As illustrated in FIG. 18, the Mapping Generator Module will receive the mapping instruction from a Mapping Program; mapping instruction contains mapping level (Row or Column Level), Source and Destination Row Identifier (3701). Thereafter, interpret mapping instruction if the mapping is at Row or Column level (3702). Then, validate if the mapping is at Row level, if there is mapping at Row level (3703). Then the system will retrieve the Source and Destination Row eDicts using Read Module (3704). Then, identify matching Source and Destination Column Name between the Source and Destination Row eDicts retrieved (3705). Then verify, if Source and Destination Column Name are matched. if Source and Destination Column Name are matched (3706). Then the system add the matching Source and Destination Column pair into a temporally list for later processing (3707). However, if Source and Destination Column Name are not matched , then further validate if there are more column to match (3708); if matches the identifying process will continue. However, if there is no mapping at Row level, then further validate if the mapping is at Column level (3709). Then, retrieve the Source and Destination Row eDicts using Read Module, if the mapping is at Column level (3710). Thereafter, from the matching pair(s), the Column Name will be translated into actual index (index of the Column Name in the eDict) by relying on the Row eDict retrieved (3711). Then, generate Mapping Program using the identified Source and Destination index(es) (3712). The Condition and Computation will generated if it's included in the mapping instruction received. Finally, store the generated Mapping Program to the database using Transaction Processing Module (3713).

The present invention may be embodied in other specific forms without departing from its essential characteristics. The described embodiments are to be considered in all respects only as illustrative and not restrictive. The scope of the invention is, therefore indicated by the appended claims rather than by the foregoing description. All changes, which come within the meaning and range of equivalency of the claims, are to be embraced within their scope.

1.-17. (canceled)

18. A system to emulate a manual filing system by storing and processing document that operates on a relational database management system, comprising:
an electronic document having at least one electronic document identifier, section, rowtype or column;
an electronic form generator module to create at least one electronic form having a predefined program based on an electronic dictionary data;
a flow diagram having pre-compiled task program set by at least one user;
an electronic business processing module generator to generate at least one task program based on the flow diagram to be stored into the electronic document;
a mapping generator module to generate data mapping program based on a graphical information;
a transaction processing module to store the generated mapping program;
a system generator module to generate process control and business rules into pre-compiled program using the electronic business processing module;
a virtual memory for storing the electronic document; and
a web-read module for retrieving the electronic document from the virtual memory based on at least one identifier of the electronic document.

19. The system according to claim 18, wherein the web-read module for retrieving the electronic document further comprises:
a paging module having the electronic document append into at least one electronic file in the relational database management system according to a predefined page limit;
an index module having at least one index for the electronic file based on a document identifier, date, end sequence number, document status, document offset and document length; and
a read module to obtain the Index and at least one data relative page of the electronic file from the index module based on the identifier, in which the electronic document retrieved from the paging module is based on the retrieved index and data relative page to be stored in the virtual memory and updating the index module.

20. The system according to claim 18, wherein the identifier of the electronic document comprises the electronic document identifier, section, rowtype or column.

21. The system according to claim 19, wherein the identifier of the electronic document comprises the document identifier, date, end sequence number, document status, document offset and document length.

22. The system according to claim 18, further comprising:
an enquiry module for retrieving a pluralities of the electronic document information based on at least one information for the electronic document identifier, section, rowtype or column of the electronic document, in which the retrieved electronic document information having at least one file history displayed into at least one list form.

23. The system according to claim 22, wherein the list form has at least one predefined information for each document.

24. The system according to claim 22, wherein the enquiry module further comprises an editing module to load the retrieved electronic document for updating the retrieved electronic document and storing at least one updated data to the virtual memory.

25. The system according to claim 22, wherein the enquiry module further comprises a viewing module to load the retrieved electronic document for viewing the retrieved electronic document.

26. The system according to claim 22, wherein the enquiry module further comprises a searching module, wherein the searching module retrieves the electronic document using the web-read module based on at least one index, in which the index is retrieved from the identifier of the electronic document comprising a document identifier, date, end sequence number, document status, document offset or document length.

27. The system according to claim 18, wherein the web-read module further comprises an uploading module to upload the electronic document based on the identifier of electronic document, in which the uploading module establishes a connection to at least one server having the relational database management system and updates the relational database management tiystem with the uploade electronic document.

28. A method to emulate a manual filing system by storing and processing document that operates on a relational database management system, comprising the steps of:
obtaining a login authentication based on at least one user input;
validating the login authentication of the user with at least one login details in a database;
retrieving at least one user security matrix information of the valid user stored in the database; and
displaying a menu having at least one list of predefined programs stored in the database based on the user security matrix information;
wherein the step of displaying at least one selection menu stored in the database based on the user's security matrix information further comprises the steps of:
loading at least one electronic business processing module generator having a predefined program, if the user selected from a displayed menu;
loading at least one electronic form generator module having a predefined program, if the user selected from the displayed menu; and
logging out and update the logout request time to the database, if the user selected from the displayed menu;
wherein the step of loading at least one electronic business processing module generator having a predefined program further comprises the steps of:
displaying a menu of having at least one list of predefined programs stored in the electronic business processing module generator;
creating at least one workflow program, if the user selected from the displayed menu;
saving the workflow program, if the user selected from the displayed menu;
loading at least one predefined workflow program, if the user selected from the displayed menu; and
exiting the predefined program of the electronic business processing module generator, if the user selected from the displayed menu.

29. The method according to claim 28, wherein the step of creating at least one workflow program further comprises the steps of:
displaying a menu having a start component, end component, condition component, flow component and save component stored in the database;
generating the start component for workflow program based on the user input, if the user selected from the displayed menu;
generating the end component for workflow program based on the user input, if the user selected from the displayed menu;
generating the condition component for workflow program based on the user input, if the user selected from the displayed menu;
generating the flow component for workflow program based on the user input, if the user selected from the displayed menu; and
saving the generated components for workflow program, if the user selected from the displayed menu.

30. The method according to claim 28, wherein the step of saving the workflow program further comprises the steps of:
extracting flow information from the workflow diagram;
generating a graphical information from the flow information;
storing the graphical information by using the transaction processing module;
generating a predefined program for at least one task of graphical information;
integrating a mapping information for the task of graphical information using the transaction processing module; and
storing the mapped task using the transaction processing module.

31. The method according to claim 28, wherein the step of loading at least one predefined workflow program further comprises the steps of:
displaying a menu having a design program, metering program and view program stored in the workflow program;
authorizing the user to edit at least one predefined task properties stored in the workflow program, if the user selected the design program from the displayed menu;
verifying operational workflow for the predefined task using a retrieval module, if the user selected the metering program from the displayed menu; and
displaying the predefined task, if the user selected the view program from the displayed menu.

32. The method according to claim 30, wherein the step of integrating a mapping information for the task of graphical information using the transaction processing module further comprises the steps of:
receiving the mapping instruction from the mapping program;
extracting a mapping instruction contains mapping level, source and destination row identifier;
interpreting the mapping instruction if the mapping is at a row or column level of the mapping level;
validating if the mapping is at the row level;
retrieving a source and destination row electronic dictionary using a read module, if there is mapping at the row level;
identifying a matching source and destination column name between the retrieved source and destination row electronic dictionary;
verifying, if the source and destination column name are matched;
adding the matching source and destination column pair into a temporally list, if source and destination column name are matched;
validating if there are more column to match;
validating if the mapping is at the column level;
retrieving the source and destination row electronic dictionary using the read module, if the mapping is at the column level;
translating the column name into actual index based on the row electronic dictionary retrieved;
generating the mapping program using the identified source and destination index;
generating at least one condition and computation based on mapping instruction received; and
storing the generated mapping program to the database using the transaction processing module.
